(19) United States
(12) Patent Application Publication
(10) Pub. No.: US 2021/0090056 A1
(43) Pub. Date: Mar. 25, 2021

(54) STORE CHECKOUT VERIFICATION SYSTEM

(71) Applicant: AHOLD DELHAIZE LICENSING SARL, Geneva (CH)

(72) Inventors: Cobin DOPKEEN, Huntersville, NC (US); Paul SCORZA, Quincy, MA (US); Jason BREAZEALE, Simpsonville, SC (US); Hank SHEEHAN, Syracuse, NY (US); Tuly HAZBAR, Rochester, NY (US); Michael KARNS, Exeter, RI (US); Scott MORRISON, Mansfield, MA (US)

(21) Appl. No.: 17/115,221

(22) Filed: Dec. 8, 2020

Related U.S. Application Data
(63) Continuation-in-part of application No. 16/138,410, filed on Sep. 21, 2018.
Application No. 16/138,410 is a continuation-in-part of application No. 16/932,083, filed on Jul. 17, 2020.
(60) Provisional application No. 62/561,361, filed on Sep. 21, 2017.
(60) Provisional application No. 62/875,044, filed on Jul. 17, 2019.

(51) Int. Cl. G06Q 20/20

(52) U.S. Cl. CPC G06Q 20/204; G06Q 20/208; G06Q 20/206; G06Q 20/202

(57) ABSTRACT

A store checkout verification system is disclosed, including at least one remote server, an integrated autonomous checkout system, at least one checkout verification system including a visual indicator, and at least one beacon. The at least one checkout verification system includes a hand-held tallying device including a scanner, memory, and a hand-held tallying device program encoded in the memory of the hand-held tallying device for recording a tally of items scanned with the scanner. The payment module includes a payment module program configured to receive a price corresponding to the tally and direct an electronic payment from an account associated with a user to a merchant in response to an instruction provided by the user. The checkout verification system activates the visual when the payment module has confirmed the electronic payment and the hand-held tallying device is within the predetermined distance of the at least one beacon.

### CROSS REFERENCE TO RELATED APPLICATIONS

This application is a continuation-in-part of U.S. Non-Provisional patent application Ser. No. 16/138,410, filed on Sep. 21, 2018 and entitled “Automated Checkout System Using Information from Customer Device,” which claims priority to U.S. Provisional Patent Application 62/561,361, filed Sep. 21, 2017 and entitled “Automated Checkout System Using Information from Customer Device,” and is a continuation-in-part of U.S. Non-Provisional patent application Ser. No. 16/932,083, filed on Jul. 17, 2020 and entitled “Integrated Autonomous Checkout System,” which claims priority to U.S. Provisional Patent Application 62/875,044, filed Jul. 17, 2019 and entitled “System and Method of Shopping,” the contents of all of which are hereby incorporated by reference in their entirety.

### FIELD

The present invention is directed to electronic payment transactions within physical store locations and, more particularly, to the utilization of mobile devices, beacons, and lights to perform and facilitate such transactions while notifying store operations.

### SUMMARY

A customer may utilize a mobile device, such as a phone, that has Bluetooth and Wi-Fi capabilities to complete a transaction based on proximity, without the need to wait for their items to be scanned at checkout or speak to a cashier. The customer may be directed to specific locations to facilitate this payment and allow for the merchant to be aware of the customer's payment activities by way of network connected lights, which turn on and off and change color to notify client and/or merchant staff of progress.

In an embodiment, a system having a customer device having a processor, a memory, and instructions in communication with a merchant device, having at least one short range wireless communication beacon, a memory, and instructions. The instructions determine the customer device is within a predetermined distance of the short range wireless communication beacon, queue the customer device to one of a plurality of point of sale locations, direct a customer, via the customer device, to the point of sale location, and process a point of sale transaction.

In another embodiment, a system comprising a customer device having a processor, a memory, and instructions in communication with a merchant device, having short range wireless communications, a memory, and instructions. The instructions determine the customer device is within a predetermined distance of a point of sale location, queue the customer device to one of a plurality of point of sale locations, direct a customer, via the customer device, to the point of sale location; and process a point of sale transaction.

In another embodiment, a method including receiving, by a merchant device, a location signal generated by a merchant application operating on an external device. The method also includes determining, by the merchant device, the external device is within a pre-determined distance from a point of sale location and providing, directions to the point of sale location to the merchant application on the external device. The method further includes processing, via the merchant device, a point of sale transaction.

In another embodiment, a store checkout verification system includes at least one remote server, an integrated autonomous checkout system, at least one checkout verification system, and at least one beacon. The integrated autonomous checkout system includes a hand-held tallying device and a payment module. The hand-held tallying device includes a scanner, memory, and a hand-held tallying device program encoded in the memory of the hand-held tallying device for recording a tally of items scanned with the scanner. The hand-held tallying device is in communication with the at least one remote server. The payment module includes a payment module program configured to receive a price corresponding to the tally and direct an electronic payment from an account associated with a user to a merchant in response to an instruction provided by the user. The at least one checkout verification system is in communication with the at least one remote server and includes a visual indicator. The at least one beacon is in communication with the at least one hand-held tallying device and emits a short-range wireless communication signal. At least one of the hand-held tallying device and the at least one beacon includes programming instructions encoded in memory thereof that signal the at least one remote server when the hand-held tallying device is within a predetermined distance of the at least one beacon. The checkout verification system includes instructions encoded in memory thereof which activate the visual indicator to display a first visual indicia upon receipt of a signal from the at least one remote server indicating that the payment module has confirmed the electronic payment and that the hand-held tallying device is within the predetermined distance of the at least one beacon.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a block diagram of a portion of the system of the present invention, according to an embodiment.

FIG. 2 is a block diagram of a point of sale the system of the present invention, according to an embodiment.

FIG. 3 is a block diagram of the interactions between the customer device and the merchant device, according to an embodiment.

FIG. 4 is an illustration of representative hardware used in the system, according to an embodiment.

FIG. 5 is a block diagram of a method of performing an automated checkout, according to an embodiment.

FIG. 6 is a block diagram of a method of performing an automated checkout, according to an embodiment.

FIG. 7 is a schematic view of a store checkout verification system, according to an embodiment.

Wherever possible, the same reference numbers will be used throughout the drawings to represent the same parts.

### DETAILED DESCRIPTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features.

Customer merchant interactions are increasingly incorporating automating technology to facilitate the selection, location, retrieval, and payment, for goods at retail locations. As a customer enters a storefront, merchant applications on the customer's devices may wirelessly connect to the merchant's network or servers to enhance the customer's shopping experience. In some embodiments, the merchant application may assist the customer in selecting desirable items. The merchant application may provide the location of items based on a pre-determined list provided by the customer. Alternatively, the merchant application may provide a list of recommended items based on the customer's history.

The merchant application may also assist the customer in locating desired items within the store. In some embodiments, the merchant application may provide a store map showing the location of the desired items. In some embodiments, the merchant application may provide directions to the customer based on the desired items location and the customer location. In some embodiments, the customer location may be determined by the global positioning system (GPS) functionality of the customer's portable electronic device, such as a cell phone or tablet.

The customer may select desired items at the retail location by scanning an identification code on the item, such as a barcode. The merchant application transmits the scanned code to the merchant's server, which stores the item information in a virtual shopping cart. The item information may include an item description, warranty information, and price. The merchant application may additionally retrieve one or more elements of the item description and display the information in a format readable to the customer, such as displaying on a cell phone screen. In some embodiments, the information displayed to the customer includes a listing of the products in the virtual shopping cart, the individual product prices, and the total price of all selected items, including taxes and fees if applicable. In some embodiments, the customer may additionally select items remotely, such as through a webpage or other electronic listing, for inclusion in the virtual cart. The remote items may later be picked up at the same or different location or delivered to a customer specified address.

In a purchase transaction between a merchant and a customer, the merchant application on the customer device sends an application programing interface (API) call to the merchant server signaling that the customer is ready to checkout. The application notifies the customer to approach the “checkout zone,” an area in which the customer will complete their transaction or in which a transaction completed via the customer device will be verified. When the customer device enters the “checkout zone,” the merchant application becomes aware of its location when it receives a short range wireless communication signal (e.g., Bluetooth beacon signal), and therefore sends an alert to the merchant server notifying the merchant server that the customer device is located in the checkout zone. Alternatively, the merchant application may become aware that a customer device has approached the point of sale or verification location through other location services (e.g., WiFi triangulation, geolocation, machine vision, GPS).

The merchant server then checks the available point of sale or verification locations and assigns the customer device to one of the locations within the checkout zone based on a queue created by order of entry with other customer devices. The merchant server sends an API call to a wirelessly controlled light, as picked by the service, such that the light turns on in a designated color, and simultaneously directs customer device to the same light acting as a point of sale or verification location within the checkout zone such that the customer stands in the immediate vicinity of a network enabled merchant checkout light. Alternatively, the merchant server may send an API call to a display to display a code unique to the customer, such as a number or letter number combination, to direct the customer to designated location within the checkout zone.

As the customer approaches the checkout location, the customer device may pair with the merchant device(s) using the short range wireless communications, such as near field communications, Bluetooth communications, Bluetooth Low Energy communication, LTE Direct communications, or other communication protocol. Once paired, the customer device may provide customer information to the paired device that identifies the customer and allows the merchant device to detect that the customer is at or nearby the checkout location. In other embodiments, the customer may be detected at or nearby the checkout location based on a location detection module of the customer device, such as a mapping or GPS module.

Upon customer device arrival, said device senses the short range wireless communication signal (e.g, Bluetooth low energy (BLE) signal) at increased strength and notifies the merchant server of the customer's immediate nearby location. The merchant server sends an API call to turn off the point of sale light and allow the customer device to begin a point of sale transaction. The customer then may use device-stored payment data or a third party payment application to pay the merchant. Alternatively, the point of sale location may provide an input device, such as a credit card or debit card reader, that allows the customer to transfer customer payment information to the merchant server or third party payment system.

Upon completion of transaction, merchant server notifies the light to turn on in a different designated color, signaling a merchant store associate of successful payment such that the customer may proceed to the store exit. The merchant application may additionally provide the customer a receipt for the transaction. The receipt may be electronic or printed.

The customer uses a payment instrument at the merchant's checkout location, such as a payment application on the customer device and offered by a payment provider (e.g., Apple Pay, Google Pay, Samsung Pay, credit card, debit card, Paypal, or Venmo). The customer may set their preference to use the application, which may be communicated to the merchant's devices and/or merchant server with the customer information. In other embodiments, the preference to use the payment application may be scraped from available data for the customer (e.g., customer information with the payment provider, online behavior, etc.) or based on available processes for the customer device and/or processes the customer is currently engaged in on the customer device (e.g., if the payment application is available on the customer device or currently open).

The customer device and merchant devices may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of the system and/or accessible over a network.

The customer device may utilize appropriate hardware and software configured for communication with a payment provider server and/or merchant device(s). For example, in one embodiment, the customer device may be implemented as a personal computer (PC), a smart phone, laptop/tablet computer, wristwatch with appropriate computer hardware resources, eyeglasses with appropriate computer hardware, other type of wearable computing device, implantable customer devices, and/or other types of computing devices capable of transmitting and/or receiving data.

The customer device may contain a payment module, a location module, other applications, a database, and a communication module. The payment module, location module, and other applications may correspond to executable processes, procedures, and/or applications with associated hardware. In other embodiments, customer device may include additional or different modules having specialized hardware and/or software as required.

The payment module may correspond to one or more processes to execute modules and associated devices of customer device to initiate, receive, and/or process/complete transactions with a merchant corresponding to the merchant device, as well as receive notifications from merchant device regarding checkout line and payment. In this regard, the payment module may correspond to specialized hardware and/or software utilized by the customer device to provide a convenient interface to permit the customer to select payment options and provide payment for items. Payment module may be implemented as a user interface enabling the customer to enter payment options for storage by the customer device, provide those payment options on checkout/payment of one or more items with the merchant corresponding to merchant device, and complete a transaction for the item(s) through a payment request for the item(s).

The customer may utilize payment module to generate a payment request for the item(s) to be purchased and provide or identify payment information to complete the transaction when checking out with merchant device in one of the checkout lines. Payment module may utilize customer financial information, such as a credit card, bank account, or other financial account, as a payment instrument when providing payment information for use in a payment request. The payment request may be communicated to payment provider server for processing to complete the transaction for the item using the customer financial information. The payment request may be communicated to a merchant server or device directly (e.g., using short range wireless communications) or over network for communication to payment provider server, or may be communicated to payment provider server over network.

Location module may correspond to one or more processes and/or specialized hardware of customer device to determine a location for customer, which may include detection of customer's location through mapping and/or GPS devices as well as utilizing short range wireless communications to connect with nearby devices. In this regard, location module may correspond to specialized hardware and/or software that may determine a location for customer while the customer is within a merchant location corresponding to merchant device that includes a checkout location having one or more checkout lines. Thus, the location module may be used to determine when customer is at or nearby the checkout location within the merchant location and/or within one of the plurality of checkout lines. Location module may correspond to a mapping or GPS module, which may be used to determine a location for customer and communicate the location to merchant device. Such location information may correspond to coordinates for the customer and/or a map location for the customer.

However, in other embodiments, location module may be used to determine that customer is at or nearby a checkout location or within a checkout line of the checkout location using short range wireless communications between customer device and merchant device, a wireless beacon, or other device located within the checkout location. The devices may pair using short range wireless communications, such as near field communication, Bluetooth, Bluetooth Low Energy, LTE Direct, radio, infrared, or other communication protocol. The connection may be established with or without customer input from customer.

Customer device includes at least one communication module adapted to communicate with payment provider server and/or merchant device. In various embodiments, communication module may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Customer module may communicate directly with nearby devices using short range communications, such as Bluetooth Low Energy, LTE Direct, Wi-Fi, radio frequency, infrared, Bluetooth, and near field communications.

A physical merchant location may include a merchant device, which may correspond to a point of sale (POS) and/or check-out machine/device. The merchant location includes checkout locations where customers may purchase goods, products, services, and/or other types of purchasable (collectively referred to as an “item” or “items” herein). The checkout location may include one or more checkout lines or areas. Thus, the merchant location may include a plurality of merchant devices functioning similar to the merchant device. The merchant device may be managed or controlled by any suitable processing device, including merchant servers and cloud computing resources.

The merchant device includes at least one communication module adapted to communicate with customer device and/or payment provider server. In various embodiments, the communication module may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. In various embodiments, the merchant device may include a communication module, which may communicate directly with customer device using short range wireless communications, such as radio frequency, infrared, Bluetooth, and near field communications.

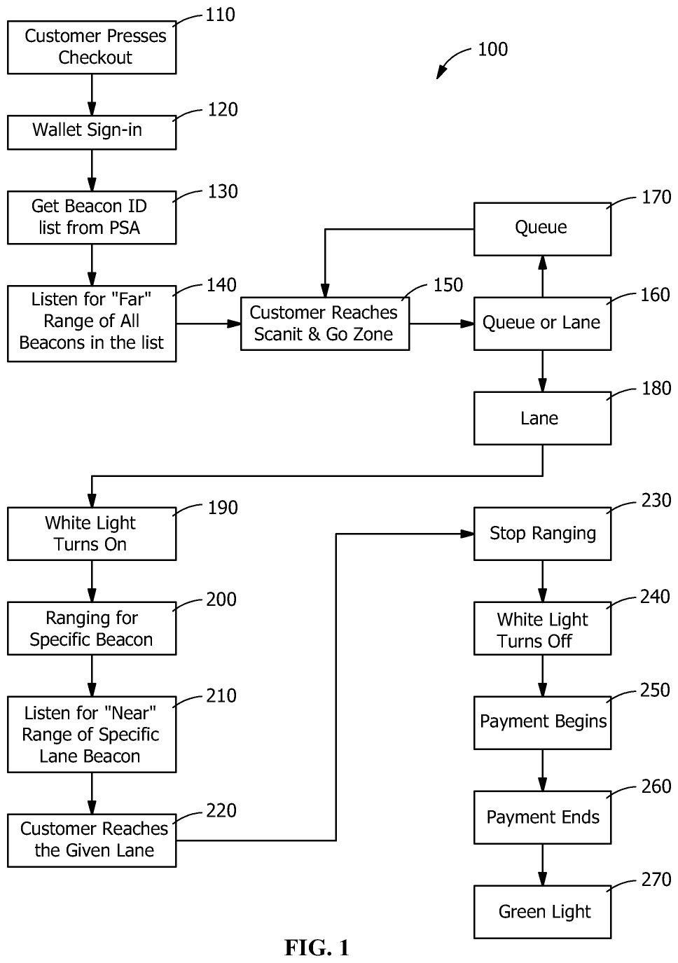

An embodiment of a point of sale method 100 is shown in FIG. 1. In the example of FIG. 1, at block 110 a customer sends a request to check-out via a portable electronic device (customer device). The customer may send the request via an application on their portable electronic device. At block 120, the customer signs into an electronic payment application (e.g., electronic wallet). In some embodiments, the electronic payment application may be provided by a third party payment vendor or the point of sale merchant as an application on the customer's portable electronic device.

At block 130, the customer device receives a point of sale beacon list of unique identifiers from a personal shopping assistant server (PSA). The PSA server may be a merchant server or be a third party server. At block 140, the customer device determines a range or location of at least one point of sale beacon. In some embodiments, the range may be determined based on a predetermined signal strength threshold. The customer device may optionally provide directions to the customer to a nearby point of sale beacon.

At block 150, the customer device determines the range to the at least one point of sale beacon is less than a predetermined threshold. At block 160, the PSA determines the availability of a point of sale location (e.g., a checkout). At block 170, if no point of sale location is available, the customer is placed in a queue for access to a point of sale location. At block 180, if a point of sale location is available, the PSA assigns the customer to a point of sale location (e.g., a checkout lane).

At block 190, the PSA activates a visual notification, such as, an indicator light (e.g., a white light), to notify the customer of the location of the checkout to which they have been assigned. Alternatively, an alpha-numeric code may be displayed at the checkout lane. In some embodiments, an audible notification may be provided alone or in combination with the visual notification.

At block 200, the customer device receives a signal from the assigned point of sale location beacon. The signal may provide the location of the assigned point of sale beacon. At block 210, the customer device determines the range to the assigned point of sale location, based on the received signal. At block 220, the customer device determines the customer has reached the assigned point of sale location. In some embodiments, it may be determined that the range to the assigned point of sale location is less than a predetermined threshold. In some embodiments, it may be determined that the point of sale beacon signal strength received by the customer device is greater than a predetermined threshold. At block 230, the merchant device discontinues range determination. At block 240, the visual notification is discontinued.

At block, 250, the payment process begins via the payment vendor. At block 260, the payment vendor notifies the PSA that the payment process has been completed. At block 270, the PSA activates a transaction completed indicator (e.g., a green light) to notify the customer and store personnel that the sale has been completed successfully.

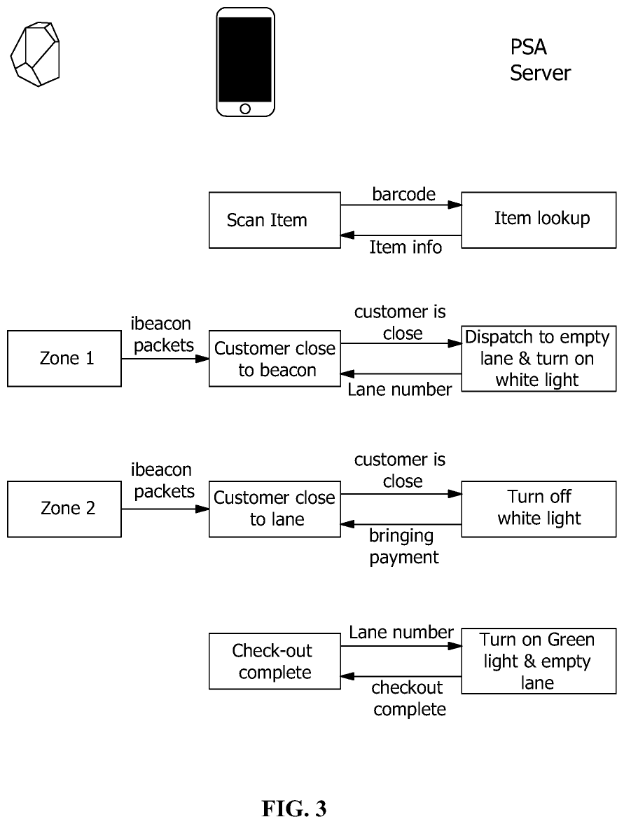

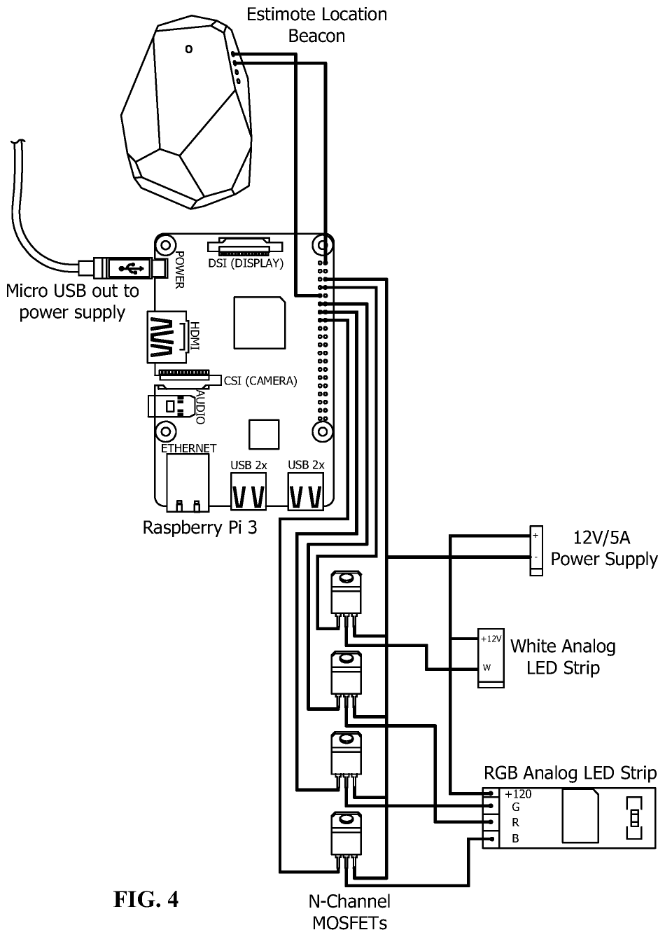

FIG. 3 is a block diagram illustrating the interactions between a point of sale beacon, customer device, and merchant device. FIG. 4 illustrates representative hardware used to implement the point of sale system.

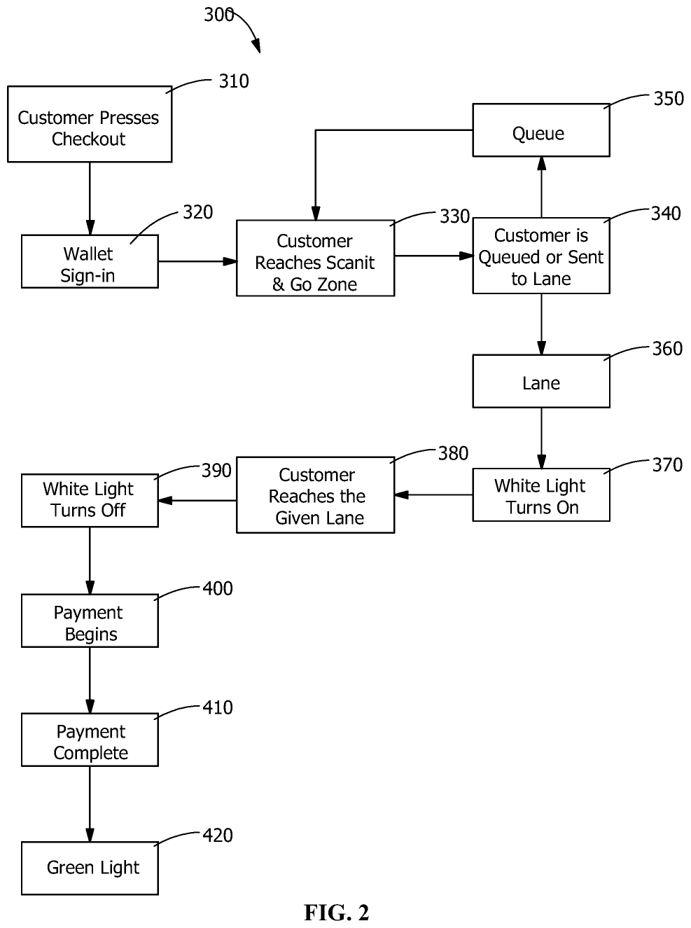

An embodiment of a point of sale method 300 is shown in FIG. 2. In the example of FIG. 2, at block 310 a customer sends a request to check-out via a portable electronic device (customer device). The customer may send the request via an application on their portable electronic device. At block 320, the customer signs into an electronic payment application. In some embodiments, the electronic payment application may be provided by a third party payment vendor or the point of sale merchant as an application on the customer's portable electronic device.

At block 330, the customer device determines the range to the at least one point of sale beacon is less than a predetermined threshold indicating the customer has reach a point of sale area. At block 340, the PSA determines the availability of a point of sale location (e.g., a checkout) within the point of sale area. At block 350, if no point of sale location is available, the customer is placed in a queue for access to a point of sale location. At block 360, if a point of sale location is available, the PSA assigns the customer to a point of sale location (e.g., a checkout lane). At block 370, the PSA activates a visual notification, such as, an indicator light (e.g., a white light), to notify the customer of the location of the checkout to which they have been assigned. Alternatively, an alpha-numeric code may be displayed at the checkout lane. In some embodiments, an audible notification may be provided alone or in combination with the visual notification.

At block 380, the customer device determines the customer has reached the assigned point of sale location. In some embodiments, it may be determined that the range to the assigned point of sale location is less than a predetermined threshold. In some embodiments, it may be determined that the point of sale beacon signal strength received by the customer device is greater than a predetermined threshold. At block 430, the merchant device discontinues range determination. At block 390, the visual notification is discontinued. At block, 400, the payment process begins via the payment vendor. At block 410, the payment vendor notifies the PSA that the payment process has been completed. At block 420, the PSA activates a transaction completed indicator (e.g., a green light) to notify the customer and store personnel that the sale has been completed successfully.

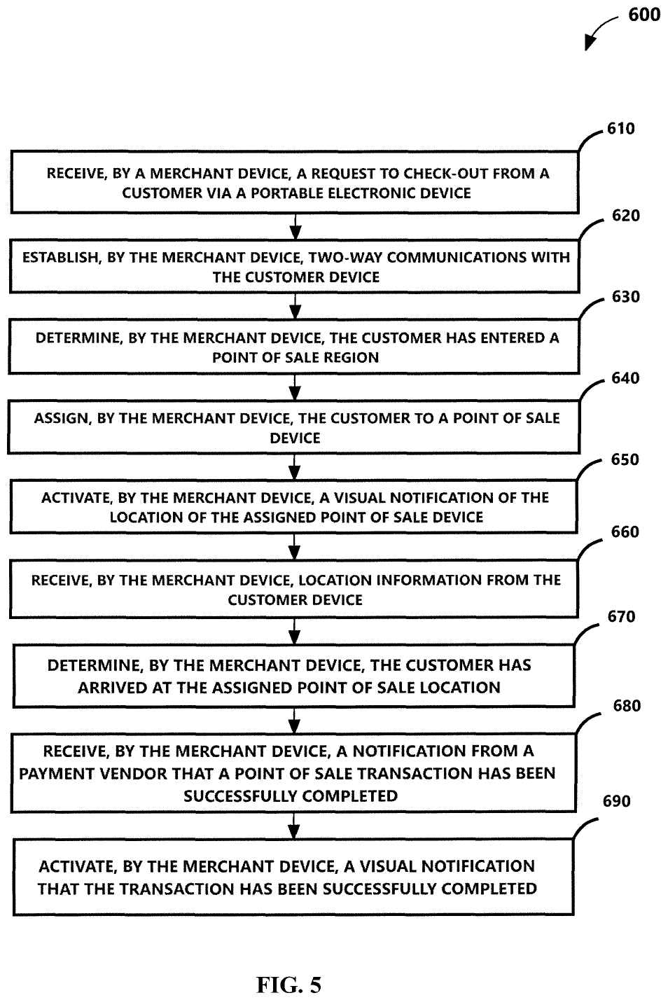

An embodiment of a point of sale method 600 is shown in FIG. 5. In the example of FIG. 5, at block 610 a merchant device (e.g., a merchant server, PSA) receives a request to check-out from a customer via a portable electronic device (customer device). The request may be an API call to the merchant server via an application on their portable electronic device (e.g., cell phone, tablet). At block 620, the merchant device establishes two-way communications with the customer device. At block 630, the merchant device determines that the customer has entered a point of sale region. At block 640, the merchant device assigns the customer to a point of sale device (e.g., a checkout, scanner, bar code reader). At block 650, the merchant device activates a visual notification of the location of the assigned point of sale device. At block 660, the merchant device receives location information from the customer device. At block 670 the merchant device determines that the customer has arrived at the assigned point of sale location. At block 680, the merchant device receives a notification from a payment vendor that a point of sale transaction has been successfully completed. At block 690, the merchant device activates a visual notification that the transaction has been successfully completed.

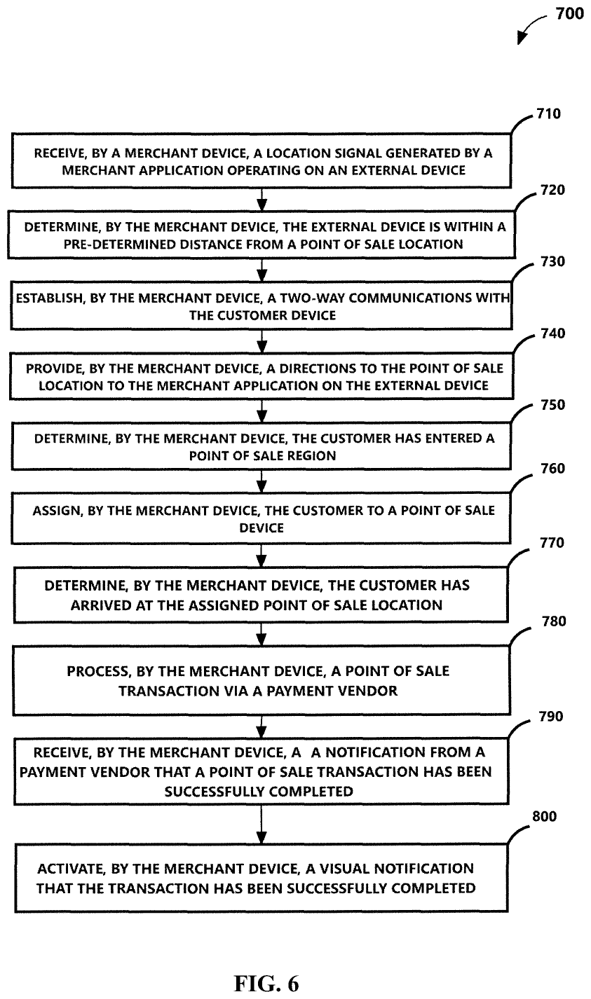

An embodiment of a point of sale method 700 is shown in FIG. 6. In the example of FIG. 6, at block 710, a merchant device (e.g., a merchant server, PSA) receives a location signal generated by a merchant application operating on an external device. At block 720, the merchant device determines the external device is within a pre-determined distance from a point of sale location. At block 730, the merchant device establishes two-way communications with the customer device. At block 740, the merchant device provides directions to the point of sale location to the merchant application on the external device. At block 750, the merchant device determines that the customer has entered a point of sale region. At block 760, the merchant device assigns the customer to a point of sale device (e.g., a checkout, scanner, bar code reader). At block 770, the merchant device determines that the customer has arrived at the assigned point of sale location. At block 780, the merchant device processes a point of sale transaction via a payment vendor. At block 790, the merchant device receives a notification from a payment vendor that a point of sale transaction has been successfully completed. At block 800, the merchant device activates a visual notification that the transaction has been successfully completed.

In some cases, a customer may have the option to pay using a personal mobile or other portable device directly through a software application accessible from the device that avoids the need for the customer to pass through a POS location prior to leaving the store. Exemplary embodiments also provide for verifying that a customer leaving store with an order has completed a payment transaction in a way that can automatically and readily communicate that fact to store personnel.

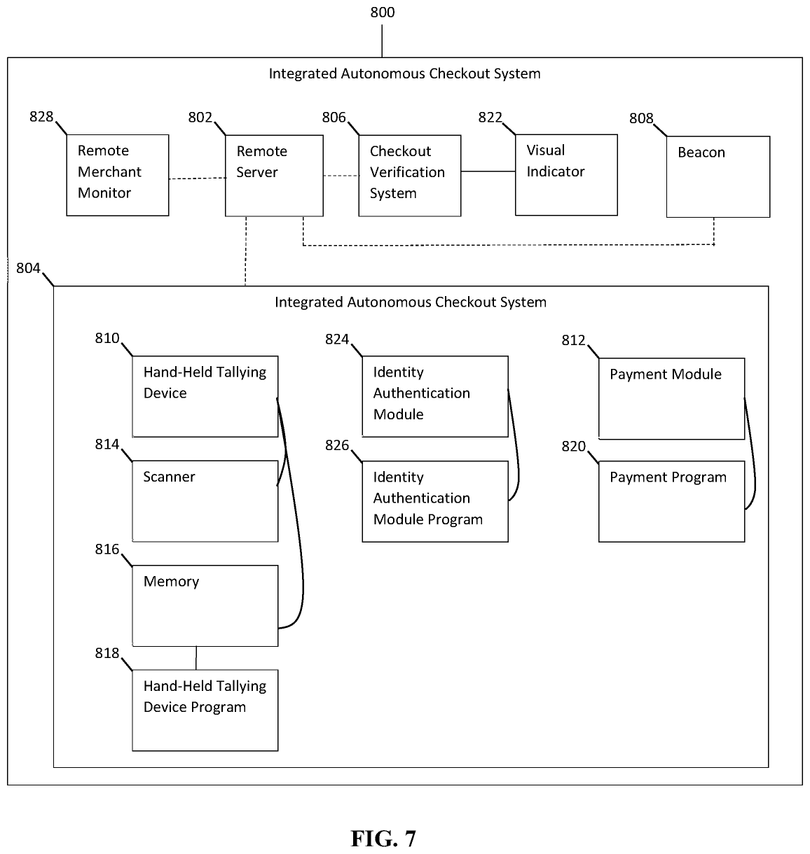

Referring to FIG. 7, in one embodiment, a store checkout verification system 800 includes at least one remote server 802, an integrated autonomous checkout system 804, at least one checkout verification system 806, and at least one beacon 808. The integrated autonomous checkout system 804 includes a hand-held tallying device 810 and a payment module 812. The hand-held tallying device 810 includes a scanner 814, memory 816, and a hand-held tallying device program 818 encoded in the memory 816 of the hand-held tallying device 810 for recording a tally of items scanned with the scanner 814. The hand-held tallying device 810 is in communication with the at least one remote server 802. The payment module 812 includes a payment module program 820 configured to receive a price corresponding to the tally and direct an electronic payment from an account associated with a user to a merchant in response to an instruction provided by the user. The at least one checkout verification system 806 is in communication with the at least one remote server 802 and includes a visual indicator 822. The at least one beacon 808 is in communication with the at least one hand-held tallying device 810 and emits a short-range wireless communication signal. At least one of the hand-held tallying device 810 and the at least one beacon 808 includes programming instructions encoded in memory thereof that signal the at least one remote server 802 when the hand-held tallying device 810 is within a predetermined distance of the at least one beacon 808. The checkout verification system 806 includes instructions encoded in memory thereof which activate the visual indicator 822 to display a first visual indicia upon receipt of a signal from the at least one remote server 802 indicating that the payment module 812 has confirmed the electronic payment and that the hand-held tallying device 810 is within the predetermined distance of the at least one beacon 802. The at least one beacon 808 may include at least one Bluetooth low energy beacon.

In one embodiment, the integrated autonomous checkout system 804 further includes an identity authentication module 824 including an identity authentication module program 826 configured to verify an identity of the user as a first authentication factor. The payment module 812 may include a second authentication factor different from the first authentication factor.

The checkout verification system 806 may include instructions encoded in memory thereof which activate the visual indicator 822 to display a second visual indicia distinct from the first visual indicia upon receipt of an alternate signal from the at least one remote server 802 indicating that the hand-held tallying device 810 is within the predetermined distance of the at least one beacon 808 and that the payment module 812 has not confirmed the electronic payment.

In one embodiment, the store checkout verification system 800 further includes a remote merchant monitor 828, wherein the remote merchant monitor 828 includes instructions encoded in memory thereof which raise an alert to merchant personnel upon receipt of the alternate signal from the at least one remote server 802 indicating that the hand-held tallying device 810 is within the predetermined distance of the at least one beacon 808 and that the payment module 812 has not confirmed the electronic payment.

The visual indicator 822 may include a signal light, a display monitor, or both placed at or on the way to one or more designated exit locations of the store. The first visual indicia and the second visual indicia may differ by color, by a signal displayed, or both. For example, a green light may be illuminated used to confirm an electronic payment was made alone or in combination with a check mark displayed on a monitor visible to store personnel. Different colors or other visual indicia may be used if an electronic payment was not detected associated with a user leaving the store with an order. In some embodiments, an audible or other sensible indicia may be used alone or in combination with the visual indicia.

Whether or not the hand-held tallying device 810 is within the predetermined distance of the at least one beacon 808 may be calculated based on a signal strength of the short-range wireless communication signal between the hand-held tallying device 810 and the at least one beacon 808, or may be calculated based on GPS data, or both.

The hand-held tallying device 810 may be a personal mobile device of the user, a merchant device retrieved from a store kiosk by the user, or both used in conjunction with one another.

The payment module program 820 may be encoded in the memory of the hand-held tallying device 810, in memory of the at least one remote server 802, or both.

In one embodiment, the at least one remote server 802 includes instructions encoded in memory thereof which virtually queue the hand-held tallying device 810 until the at least one checkout verification system 806 is available for use and then transmits an instruction to the hand-held tallying device 810 indicating that the at least one checkout verification system 806 is available for use. The hand-held tallying device 810 may include instructions encoded in the memory thereof which, upon receipt of the instruction indicating that the at least one checkout verification system 806 is available for use, displays a notification to the user to approach the at least one checkout verification system 806. When the checkout verification system 806 is available for use, the at least one remote server 802 may transmit a further instruction to the at least one checkout verification system 806 to display a reservation visual indicia corresponding to the hand-held tallying device 810.

While the invention has been described with reference to a preferred embodiment, it will be understood by those skilled in the art that various changes may be made, and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials and components, without departing from the spirit or essential characteristics thereof. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive.

### GLOSSARY OF TERMS

Scan: Image recognition of barcode

ibeacon: a protocol developed by Apple. It is based on Bluetooth low energy proximity sensing by transmitting a universally unique identifier picked up by a compatible app or operating system. The technology enables smartphones, tablets and other devices to perform actions when in close proximity to an iBeacon.

Beacon: Short range wireless communication enabled pieces of hardware that transmit messages to other devices like smartphones and tablets.

Ranging: determining the relative proximity of one or more beacons in the region and to be notified when that distance changes

PSA: Personal Shopping Assistant server

What is claimed is:

1. A store checkout verification system, comprising:
at least one remote server;
an integrated autonomous checkout system, including:
a hand-held tallying device including a scanner, memory, and a hand-held tallying device program encoded in the memory of the hand-held tallying device for recording a tally of items scanned with the scanner, the hand-held tallying device being in communication with the at least one remote server; and
a payment module including a payment module program configured to receive a price corresponding to the tally and direct an electronic payment from an account associated with a user to a merchant in response to an instruction provided by the user;
at least one checkout verification system in communication with the at least one remote server, the at least one checkout verification system including a visual indicator; and
at least one beacon in communication with the at least one hand-held tallying device, the at least one beacon emitting a short-range wireless communication signal,
wherein at least one of the hand-held tallying device and the at least one beacon includes programming instructions encoded in memory thereof that signal the at least one remote server when the hand-held tallying device is within a predetermined distance of the at least one beacon, and
wherein the checkout verification system includes instructions encoded in memory thereof which activate the visual indicator to display a first visual indicia upon receipt of a signal from the at least one remote server indicating that the payment module has confirmed the electronic payment and that the hand-held tallying device is within the predetermined distance of the at least one beacon.

2. The system of claim 1, wherein the integrated autonomous checkout system further includes an identity authentication module including an identity authentication module program configured to verify an identity of the user as a first authentication factor.

3. The system of claim 2, wherein the payment module includes a second authentication factor different from the first authentication factor

4. The system of claim 1, wherein the checkout verification system includes instructions encoded in memory thereof which activate the visual indicator to display a second visual indicia distinct from the first visual indicia upon receipt of an alternate signal from the at least one remote server indicating that the hand-held tallying device is within the predetermined distance of the at least one beacon and that the payment module has not confirmed the electronic payment.

5. The system of claim 1, further including a remote merchant monitor, wherein the remote merchant monitor includes instructions encoded in memory thereof which raise an alert to merchant personnel upon receipt of the alternate signal from the at least one remote server indicating that the hand-held tallying device is within the predetermined distance of the at least one beacon and that the payment module has not confirmed the electronic payment.

6. The system of claim 1, wherein the visual indicator includes at least one of a signal light and a display monitor.

7. The system of claim 1, wherein whether or not the hand-held tallying device is within the predetermined distance of the at least one beacon is calculated based on a signal strength of the short-range wireless communication signal between the hand-held tallying device and the at least one beacon.

8. The system of claim 1, wherein whether or not the hand-held tallying device is within the predetermined distance of the at least one beacon is calculated based on GPS data.

9. The system of claim 1, wherein the at least one beacon includes at least one Bluetooth low energy beacon.

10. The system of claim 1, wherein the hand-held tallying device is a personal mobile device of the user.

11. The system of claim 1, wherein the hand-held tallying device is a merchant device retrieved from a store kiosk by the user.

12. The system of claim 1, wherein the hand-held tallying device includes is a personal mobile device of the user and a merchant device retrieved from a store kiosk by the user being used in conjunction with one another.

13. The system of claim 1, wherein the payment module program is encoded in the memory of the hand-held tallying device.

14. The system of claim 1, wherein the payment module program is encoded in memory of the at least one remote server.

15. The system of claim 1, wherein the payment module program is encoded in the memory of the hand-held tallying device and in memory of the at least one remote server.

16. The system of claim 1, wherein the at least one remote server includes instructions encoded in memory thereof which virtually queue the hand-held tallying device until the at least one checkout verification system is available for use and then transmits an instruction to the hand-held tallying device indicating that the at least one checkout verification system is available for use.

17. The system of claim 16, wherein the hand-held tallying device includes instructions encoded in the memory thereof which, upon receipt of the instruction indicating that the at least one checkout verification system is available for use, displays a notification to the user to approach the at least one checkout verification system.

18. The system of claim 16, wherein when the checkout verification system is available for use, the at least one remote server transmits a further instruction to the at least one checkout verification system to display a reservation visual indicia corresponding to the hand-held tallying device.
